(19) United States
(12) Patent Application Publication
(10) Pub. No.: US 2012/0316663 A1
(43) Pub. Date: Dec. 13, 2012

(54) RADIO BROADCAST RECEPTION DEVICE

(75) Inventors: Shunsuke Sasanabe, Kanagawa (JP); Kouichi Ohuchi, Kanagawa (JP)

(73) Assignee: Panasonic Corporation, Osaka (JP)

(21) Appl. No.: 13/579,307

(22) PCT Filed: Feb. 18, 2011
(86) PCT No.: PCT/JP2011/000929

§ 371 Date: Aug. 16, 2012

(30) Foreign Application Priority Data
Feb. 19, 2010 (JP) 2010-034465
Dec. 24, 2010 (JP) 2010-287300

(51) Int. Cl. G06F 19/00

(52) U.S. Cl. 700/94

(57) ABSTRACT

A radio broadcast reception device includes a radio DSP which performs a signal process on analog radio audio by using a radio DSP parameter, an audio DSP which performs a signal process on digital radio audio by using an audio DSP parameter, a controlling section which outputs a switching signal in accordance with the quality of a received radio wave of a digital radio broadcast, and a blending section which switches between an output of the radio DSP and an output of the audio DSP. In accordance with the switching signal, while maintaining an output level constant, the blending section gradually switches between the output of the radio DSP and the output of the audio DSP, during a predetermined time period.

This application is a U.S. National Phase Application of PCT International Application PCT/JP2011/000929, filed Feb. 18, 2011.

The application is based on Japanese Patent Application (No. 2010-034465) filed Feb. 19, 2010 and Japanese Patent Application (No. 2010-287300) filed Dec. 24, 2010, and their disclosure is incorporated herein by reference.

### TECHNICAL FIELD

The present invention relates to a radio broadcast reception device which receives a simultaneous broadcasting such as IBOC (In-Band-On-Channel), and which switchingly outputs audio signals pertaining to a digital radio broadcast and an analog radio broadcast.

### BACKGROUND ART

As a radio broadcast reception device which receives a simultaneous broadcasting, conventionally, known is a device in which, before or at the latest audio switching between a digital radio broadcast and an analog radio broadcast, audio frequency characteristics pertaining to the digital radio broadcast are matched with those pertaining to the analog radio broadcast, whereby, at the timing of the switching, audio switching is allowed to be performed between the digital radio broadcast and analog radio broadcast in which the audio frequency characteristics are matched (for example, see Patent Reference 1).

### PRIOR ART REFERENCE

### Patent Reference

Patent Reference 1: JP-A-2006-109121

### SUMMARY OF THE INVENTION

### Problem to be Solved by the Invention

In a recent radio broadcast reception device, however, various signal processes are performed in order that, during reception of an analog radio broadcast, noises are removed or the audio sound quality is improved by using a DSP (Digital Signal Processor). Even when a control for conforming or equalizing audio frequency characteristics, such as the above-described control in a conventional radio broadcast reception device is applied to a recent radio receiving device, therefore, an audio change which is generated during audio switching between a digital radio broadcast and an analog radio broadcast cannot be sufficiently reduced, thereby causing a problem in that the user is provided with an unpleasant sense.

The invention has been conducted in order to solve the problem of the prior art. It is an object of the invention to eliminate a sound quality change during audio switching between a digital radio broadcast and an analog radio broadcast, by applying a parameter (DSP parameter) which is applied to the currently received analog radio broadcast, also to audio of the digital radio broadcast.

The invention has been conducted in order to solve the above-discussed problem of the prior art. It is another object of the invention to provide a radio broadcast reception device in which a sense of discomfort caused by a volume difference in switching between a digital radio broadcast and an analog radio broadcast can be further reduced.

### Means for Solving the Problem

The radio broadcast reception device of the invention is a radio broadcast reception device in which, with respect to a digital radio broadcast and analog radio broadcast that are performing a simultaneous broadcasting, an audio output is switched between digital radio audio pertaining to the digital radio broadcast and analog audio pertaining to the analog radio broadcast, in accordance with a quality of a received radio wave of the digital radio broadcast, the radio broadcast reception device including: a radio DSP that performs a signal process on analog radio audio by using a radio DSP parameter; an audio DSP that performs a signal process on the digital radio audio by using an audio DSP parameter; a controlling section that outputs a switching signal in accordance with the quality of the received radio wave of the digital radio broadcast; and a blending section which switches between an output of the radio DSP and an output of the audio DSP, and in accordance with the switching signal, while maintaining an output level constant, the blending section gradually switches between the output of the radio DSP and the output of the audio DSP during a predetermined time period.

Furthermore, the radio broadcast reception device of the invention is a radio broadcast reception device in which, with respect to a digital radio broadcast and analog radio broadcast that are performing a simultaneous broadcasting, an audio output is switched between digital radio audio pertaining to the digital radio broadcast and analog audio pertaining to the analog radio broadcast, in accordance with a quality of a received radio wave of the digital radio broadcast, the radio broadcast reception device including: a radio DSP that performs a signal process on analog radio audio by using a radio DSP parameter; an audio DSP that performs a signal process on the digital radio audio by using an audio DSP parameter; a controlling section that outputs a switching signal in accordance with the quality of the received radio wave of the digital radio broadcast; and a blending section which switches between an output of the radio DSP and an output of the audio DSP, and in accordance with the switching signal, the blending section gradually switches between the output of the radio DSP and the output of the audio DSP during a predetermined time period to gradually change an output amount of the audio DSP during the predetermined time period.

### Advantageous Effects of the Invention

According to the invention, the parameter of the radio DSP adapted to the analog radio audio is controlled and supplied to the audio DSP in a well-timed manner, whereby the characteristics (the frequency characteristic, the stereo/monaural characteristic, the separation characteristic, etc.) of the digital radio audio can be made close to those of the analog radio audio. Therefore, it is possible to achieve an effect that the user can listen to the output audio of the radio broadcast reception device without feeling a sense of discomfort.

According to the invention, furthermore, the volume of the digital radio audio is adjusted in accordance with the characteristics of the digital radio audio, whereby an effect is achieved in which the user is enabled to listen to the output audio of the radio broadcast reception device, with a further reduced degree of a sense of discomfort as compared with the configuration where the characteristics (the frequency characteristic, the stereo/monaural characteristic, and the separation characteristic) of the digital radio audio are simply made close to those of the analog radio audio.

### BRIEF DESCRIPTION OF THE DRAWINGS

FIG. 1 is a block diagram of a radio receiving device of Embodiment 1 of the invention.

FIG. 2(a) is a flowchart of audio switching from analog audio to digital audio in Embodiment 1 of the invention, and FIG. 2(b) is a flowchart of audio switching from digital audio to analog audio in Embodiment 1 of the invention.

FIG. 3(a) is a view showing transition of the sound pressure level in audio switching from analog audio to digital audio in Embodiment 1 of the invention, and FIG. 3(b) is a view showing transition of the sound pressure level in audio switching from digital audio to analog audio in Embodiment 1 of the invention.

FIG. 4 is a block diagram of a radio receiving device of Embodiment 2 of the invention.

FIG. 5(a) is a flowchart of audio switching from analog audio to digital audio in Embodiment 2 of the invention, and FIG. 2(b) is a flowchart of audio switching from digital audio to analog audio in Embodiment 2 of the invention.

FIG. 6(a) is a view showing transition of the sound pressure level in audio switching from analog audio to digital audio in Embodiment 2 of the invention, and FIG. 6(b) is a view showing transition of the sound pressure level in audio switching from digital audio to analog audio in Embodiment 2 of the invention.

FIG. 7 is a view showing transition of the frequency characteristic in audio switching from analog audio to digital audio.

FIG. 8 is a view showing relationships between transition of a volume difference adjustment parameter and that of the sound pressure level in audio switching from analog audio to digital audio in Embodiment 2 of the invention.

FIG. 9 is a view showing transition of the frequency characteristic in audio switching from digital audio to analog audio.

FIG. 10 is a view showing relationships between transition of a volume difference adjustment parameter and that of the sound pressure level in audio switching from digital audio to analog audio in Embodiment 2 of the invention.

### MODE FOR CARRYING OUT THE INVENTION

Hereinafter, radio broadcast reception devices of embodiments of the invention will be described with reference to the drawings.

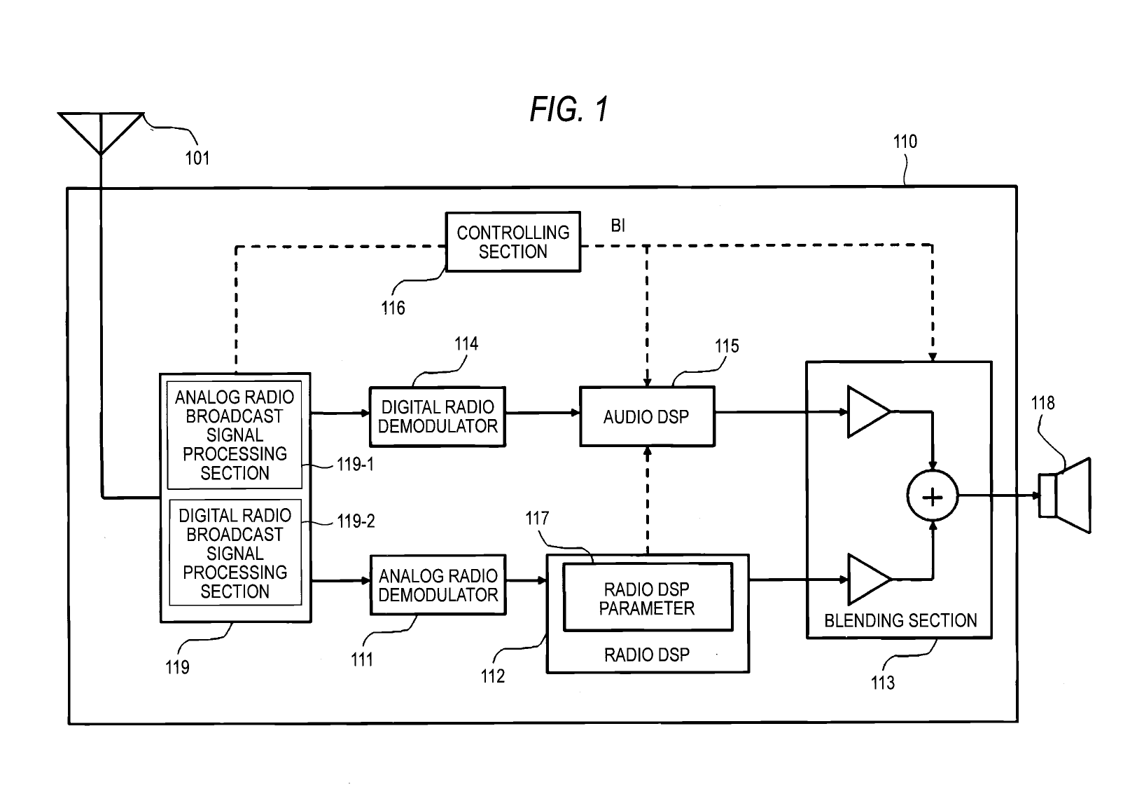

FIG. 1 is a block diagram of a radio broadcast reception device of Embodiment 1 of the invention.

Referring to FIG. 1, the radio broadcast reception device 110 is a radio broadcast reception device for receiving a simultaneous broadcasting such as IBOC.

The radio broadcast reception device 110 is configured so as to be connectable to an antenna 101, and has a broadcast signal processing section 119 having: an analog radio broadcast signal processing section 119-1 which applies a signal process to the broadcast wave of an analog broadcast in the broadcast wave received by the antenna 101, to convert it to a desired IF signal; and a digital radio broadcast signal processing section 119-2 which applies a signal process to the broadcast wave of a digital broadcast in the broadcast wave received by the antenna 101, to convert it to a desired IF signal.

The radio broadcast reception device further includes: an analog radio demodulator 111 which demodulates an analog radio broadcast from the IF signal output from the analog radio broadcast signal processing section 119-1 of the broadcast signal processing section 119; and a radio DSP 112 which is connected to the analog radio demodulator 111, and which is used for performing a signal process pertaining to the sound quality, the volume, and the like on the signal demodulated in the analog radio demodulator 111.

Similarly, the radio broadcast reception device 110 includes: a digital radio demodulator 114 which demodulates a digital radio broadcast from the IF signal output from the digital radio broadcast signal processing section 119-2 of the broadcast signal processing section 119; and an audio DSP 115 which is connected to the digital radio demodulator 114, and which is used for performing a signal process pertaining to the volume, the sound quality, and the like on the signal demodulated in the digital radio demodulator 114.

The radio broadcast reception device 110 further has a blending section 113 which combines or switches (performs a blending process on) an analog radio audio signal that is an output signal of the radio DSP 112 and a digital radio audio signal that is an output signal of the audio DSP 115, and which outputs the result of the process to the subsequent stage.

The radio broadcast reception device 110 further includes a controlling section 116 which is connected to the analog radio broadcast signal processing section 119-1, the digital radio broadcast signal processing section 119-2, and the blending section 113, and which outputs a blend signal BI that is an analog/digital switching signal for performing a control for switching the analog radio audio signal and the digital radio audio signal in accordance with the reception situation of the broadcast wave.

Here, the controlling section 116 includes, for example, a CPU, a ROM, and a RAM. The CPU executes computer programs stored in the ROM while using the RAM as a work area.

The audio signal which is switched and output in the blending section 113 is amplified by an amplifier or the like which is not shown, and then output as sound from a speaker 118 or the like to the listener. However, it is not always necessary to amplify the signal by an amplifier or the like, and a headphone or the like may be used in place of the speaker 118.

Hereinafter, the process operation of the thus configured radio broadcast reception device 110 will be described.

In the embodiment, the process operation from the input of a broadcast wave to the radio broadcast reception device 110 through the antenna 101, to the outputs of the IF signals which are obtained by the signal process in the analog radio broadcast signal processing section 119-1 and the digital radio broadcast signal processing section 119-2 is similar to that of the prior art. Therefore, the process subsequent to the operation will be described below.

First, the operation of the radio broadcast reception device 110 of the embodiment will be briefly described.

A broadcast wave is input to the radio broadcast reception device 110 through the antenna 101, and signals indicative of the quality (reception situation) of a received radio wave which is obtained in the courses where the analog radio broadcast signal processing section 119-1 and the digital radio broadcast signal processing section 119-2 perform the signal process is supplied to the controlling section 116.

In IBOC, a digital radio broadcast and an analog radio broadcast are multiplexed, and transmitted over the same carrier wave. The quality of the received wave of the digital radio broadcast can be detected from the field intensity of the received wave, the level of the audio signal pertaining to the analog radio broadcast, the C/N or S/N of a signal which is obtained by demodulating a digital radio broadcast portion of the received wave, the bit error rate of a signal which is obtained by decoding the demodulation signal, etc.

When the quality of the currently received wave is detected, the controlling section 116 switches the audio output of the radio broadcast reception device 110 in accordance with the detected quality. When the audio output is to be switched, the controlling section 116 outputs the blend signal BI to the blending section 113 (for example, High is switched to Low, or Low is switched to High), whereby the switching operation is performed in the blending section 113, so that the digital radio audio output and the analog audio output are switched over.

The case where the controlling section 116 switches between the analog radio audio and the digital radio audio is a case where, when the reception situation is worsened, the obtaining of the digital radio audio is disabled, and therefore the digital radio audio output is switched to the analog radio audio output, and, when the reception situation is improved, the analog radio audio output is switched to the digital radio audio output. In this case, however, the blending section 113 performs the switching operation while maintaining the output level constant.

Next, the process operation in the embodiment in the case where the audio output of the radio broadcast reception device 110 is switched from the analog radio audio output to the digital radio audio output, and that in the case where the audio output is switched from the digital radio audio output to the analog radio audio output will be described below.

The blend signal BI which is output from the controlling section 116 when the audio output of the radio broadcast reception device 110 is switched from the analog radio audio output to the digital radio audio output, or when the audio output is switched from the digital radio audio output to the analog radio audio output is supplied also to the audio DSP 115. The timing of application of a radio DSP parameter 117 is controlled by using the blend signal BI.

In the case where the analog radio audio output is switched to the digital audio output, in the switching, for example, immediately after the start of the switching, a radio DSP parameter (a parameter which is used in the signal process performed by the radio DSP) is applied to an audio DSP parameter (a parameter which is used in the signal process performed by the audio DSP).

This is performed in order that the digital audio characteristic in the switching is made identical with the analog audio characteristic immediately before the completion of the switching, and a sense of discomfort during the switching is reduced.

During the switching, furthermore, the radio DSP parameter is immediately applied to the audio DSP parameter, and thereafter the parameter is gradually invalidated as time progresses.

This causes the characteristic to approach to the original one of the digital audio, and the analog audio can transit to the digital audio without causing a sense of discomfort.

By contrast, in the case where the digital radio audio output is to be switched to the analog audio output, in the switching, the radio DSP parameter is not applied immediately after the start of the switching, and the parameter is gradually validated as time progresses.

This causes the digital audio to gradually approach the analog audio characteristic, and is made identical with the analog audio characteristic immediately before the completion of the switching, and a sense of discomfort in audio during the switching can be reduced.

Here, the radio DSP parameter 117 is used in order to apply a parameter applied to the analog radio audio, to the digital radio audio. When the radio DSP parameter 117 is supplied to the audio DSP 115, the signal process of the digital radio audio is performed in accordance with the parameter value.

Here, the parameter is s parameter which is used when the audio signal is subjected to s signal process in the audio DSP 115 so that the frequency characteristic and the like of the audio signal supplied to the audio DSP 115 have optimum values (values which are previously calculated and set in accordance with the field intensity in order to reduce the noise feeling of the received audio) in correspondence with a change (the reception situation) of the field intensity of the received broadcast wave, and includes a parameter for increasing or decreasing the audio separation value in correspondence with the increase or decrease of the field intensity, that for increasing or decreasing the amount of audio muting in correspondence with the increase or decrease of the field intensity, that for reducing the lower or higher frequency range of the frequency characteristic of audio in correspondence with the increase or decrease of the field intensity, etc.

These parameters are stored in the form of a data table in a memory disposed in the radio DSP 112.

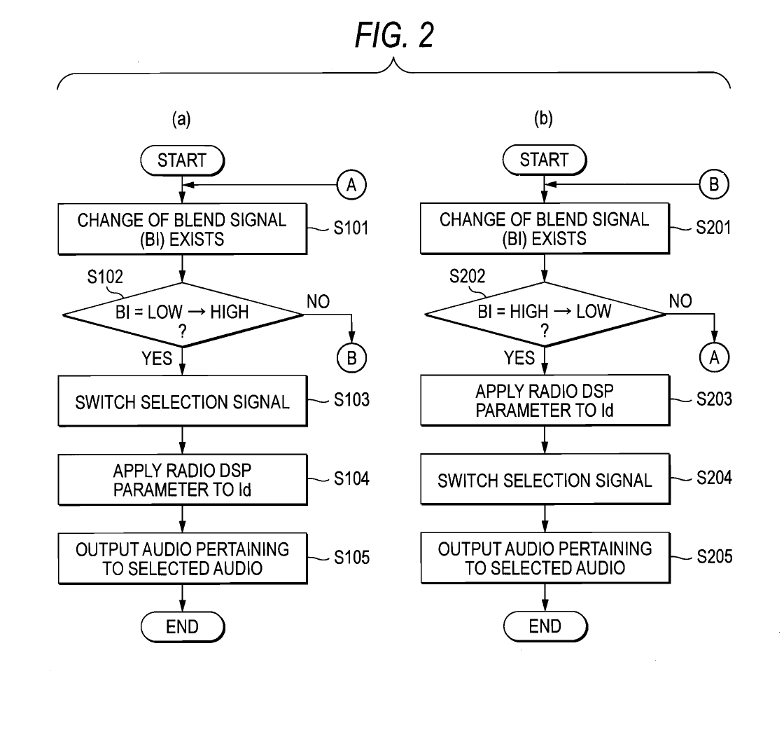

Hereinafter, the operation process flow of the radio broadcast reception device of the embodiment will be described in detail with reference to flowcharts. FIG. 2 is a flowchart of the audio switching process in the radio broadcast reception device 110 of the embodiment of the invention.

In the embodiment, when the audio output of the radio broadcast reception device 110 is to be switched from the analog radio audio output to the digital radio audio output, the output is switched by the blend signal BI as described above. In the following description, it is assumed that the blend signal BI is a signal having either of voltages indicative of two values of High and Low.

In the following description, after the blend signal BI is switched from Low to High, for example, the radio broadcast reception device 110 outputs the digital audio, and, after the blend signal BI is switched from High to Low, outputs the analog audio.

As shown in FIG. 2(a), the audio DSP 115 always monitors the existence of a High/Low change of the blend signal BI (step S101).

When it is detected in step S101 that the blend signal BI changes, the audio DSP 115 determines whether the blend signal BI changes from Low to High or not (step S102).

If the result of the determination in step S102 is No, i.e., if it is determined that the blend signal BI does not change from Low to High, the process of the audio DSP 115 is transferred to that of step S201 in the process flow shown in FIG. 2(b) which will be described later.

If the audio DSP 115 detects that a change from Low to High is conducted (Yes in step S102), the blending section 113 executes the blending process to switch the audio output of the radio broadcast reception device 110 from the analog audio to the digital audio (step S103).

At this time, the parameter (radio DSP parameter) which is supplied from the radio DSP is applied to the digital audio which is switched in step S103, by the audio DSP (step S104).

Thereafter, the digital audio to which the radio DSP parameter is applied in step S104 by the audio DSP is output as the audio output from the radio broadcast reception device 110 (step S105).

In the case where the radio DSP parameter is applied in step S104 to the digital audio by the audio DSP 115, the process is performed with a time constant τ1 as a predetermined time period for application (application time period).

As shown in FIG. 2(b), the audio DSP 115 always monitors the existence of a High/Low change of the blend signal BI (step S201).

When it is detected in step S201 that the blend signal BI changes, the audio DSP 115 determines whether the blend signal BI changes from High to Low or not (step S202).

If the result of the determination in step S202 is No, i.e., if it is determined that the blend signal BI does not change from High to Low, the process of the audio DSP 115 is transferred to that of step S101 in the process flow shown in FIG. 2(a) which has been described.

If the audio DSP 115 detects that a change from High to Low is conducted (Yes in step S202), the parameter (radio DSP parameter) which is supplied from the radio DSP is applied to a digital audio signal Id, by the audio DSP 115 (step S203).

At this time, when the application of the radio DSP parameter to the digital audio signal Id in step S203 is completed, the audio output of the radio broadcast reception device 110 is switched from the digital audio to the analog audio (step S204).

In step S204, thereafter, the analog audio is output as the audio output from the radio broadcast reception device 110 (step S205).

In the case where the radio DSP parameter is applied in step 204 to the digital audio by the audio DSP 115, the process is performed with a time constant τ4 as a predetermined time period for application (application time period).

Here, a change of the output audio when the audio output is switched and the radio DSP parameter is applied to the digital audio will be described in detail.

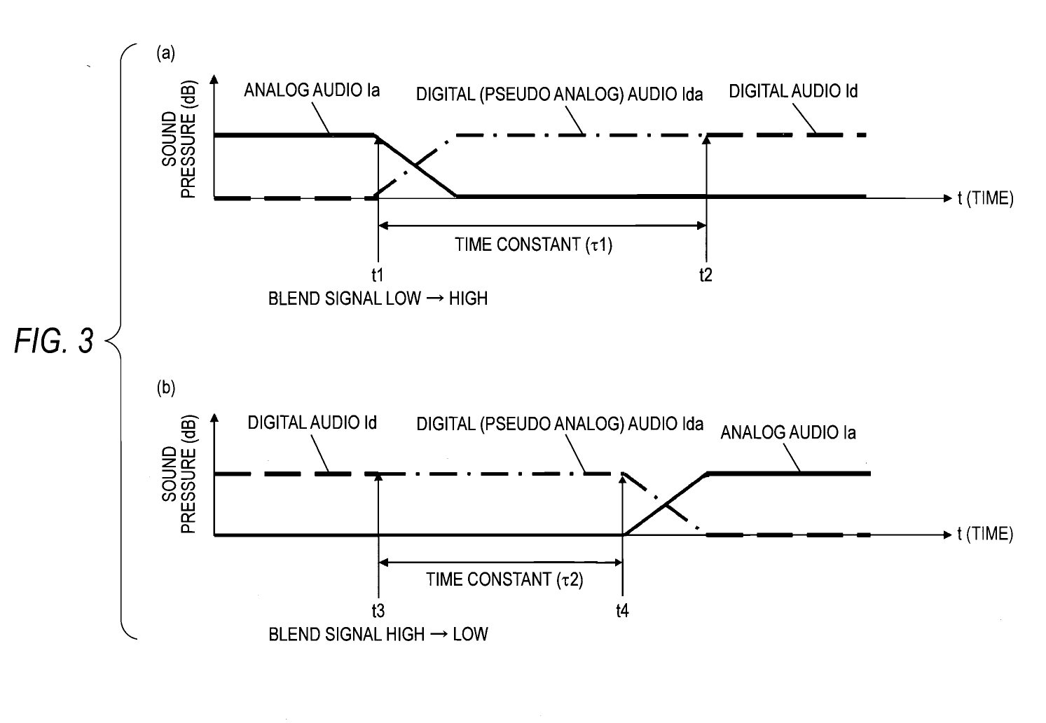

FIG. 3(a) is a view showing actual audio switching (the waveform which is monitored in the speaker 118 (see FIG. 1)). In the figure, the solid line indicates analog audio Ia, the broken line indicates the digital audio Id, and the dash-dot line indicates pseudo analog audio (digital audio to which the radio DSP parameter is applied) Ida.

In the period before time t1 shown in FIG. 3(a), a situation where the analog audio Ia is reproduced is shown. When the blend signal BI is switched from Low to High at time t1, the process of switching the output audio from the analog audio Ia to the digital audio Id is started in the audio DSP 115.

The period from time t1 to time t2 is a period which is set by the time constant τ1, and during which the process on the audio output is performed in the audio DSP 115 in the following manner.

After time t1, namely, the sound pressure of the analog audio Ia is gradually lowered, and that of the digital audio Id is gradually raised. At this time, the sound pressure of each audio is controlled so that the sum of the sound pressure of the analog audio and that of the digital audio is equal to the sound pressure of the analog audio which is obtained before time t1.

The digital audio at this time is the pseudo analog audio Ida (audio to which the radio DSP parameter is applied by the audio DSP 115).

In the pseudo analog audio Ida, after time t1, the radio DSP parameter is instantly applied, and, after the application, the applied radio DSP parameter is gradually cancelled. Then, it reaches time t2.

For example, it is controlled so that, instantly at time t1, the radio DSP parameter is applied to the digital audio Id, and, during the subsequent period until time t2, the application of the radio DSP parameter is gradually cancelled. After time t2, the digital audio Id in which the radio DSP parameter is completely canceled is output at the same sound pressures as that before time t1.

However, the period (the period indicated by a time constant τ1) of the pseudo analog audio Ida is variable. After the radio DSP parameter is completely applied, it is possible that the application of the radio DSP parameter is instantly cancelled and the audio is returned to the digital audio Id, and it is also possible that the audio is returned to the digital audio while spending considerable time.

The request for immediately listening to the digital audio Id can be complied by instantly cancelling the application of the radio DSP parameter. In a weak electric field area, however, the switching between the analog audio Ia and the digital audio Id frequently occurs, and therefore a noticeable sense of discomfort is produced during switching.

In the case where a sense of discomfort during switching is to be reduced, the application of the radio DSP parameter is cancelled while spending considerable time. According to the configuration, the frequency of switching between the analog audio Ia and the digital audio Id can be suppressed, and the sense of discomfort in audio can be reduced.

In the period before time t3 shown in FIG. 3(a), a situation where the digital audio is reproduced is shown. When the blend signal BI is switched from High to Low at time t3, the process of switching the output audio from the digital audio Id to the analog audio Ia is started in the audio DSP 115.

The period from time t3 to time t4 is a period which is set by the time constant τ2, and during which the process on the audio output is performed in the audio DSP 115 in the following manner.

After time t3, namely, a process of gradually applying the radio DSP parameter to the digital audio so that the digital audio is made close to the analog audio Ia is performed.

The digital audio at this time is the pseudo analog audio Ida (audio to which the radio DSP parameter is applied by the audio DSP 115).

In the pseudo analog audio Ida, after time t3, the radio DSP parameter is gradually applied, and, at the timing when it reaches time t4, the parameter is completely applied (at the timing when it reaches time t4, the characteristic is identical with the analog audio characteristic).

At the timing when it reaches time t4, the process of switching between the digital audio (pseudo analog audio) and the analog audio is completed, and the analog audio Ia is output.

However, the period (the period indicated by the time constant τ2) of the pseudo analog audio Ida is variable. It is possible that the application of the radio DSP parameter is instantly performed and the audio is returned to the analog audio Ia, and it is also possible that the audio is returned to the analog audio while spending considerable time.

The request for immediately listening to the analog audio Ia can be complied by instantly applying the radio DSP parameter. In a weak electric field area, however, the switching between the analog audio and the digital audio frequently occurs, and therefore a noticeable sense of discomfort is produced during switching.

In the case where a sense of discomfort during switching is to be reduced, the application of the radio DSP parameter is performed while spending considerable time. According to the configuration, the frequency of switching between the analog audio Ia and the digital audio Id can be suppressed, and the sense of discomfort in audio can be reduced.

As described above, the embodiment includes the audio DSP which can apply the radio DSP parameter. Therefore, the radio DSP parameter can be applied to digital audio, and a signal processing can be performed. Consequently, the digital audio can be conformed to the analog audio which is currently output.

The period when the radio DSP parameter is applied to the digital audio is set variable, whereby the parameter is made valid or invalid while spending considerable time. Therefore, a sense of discomfort during switching between analog audio and digital audio can be reduced.

In a weak electric field area, the switching between analog audio and digital audio frequently occurs, and therefore a noticeable sense of discomfort is produced during switching. Even in such an environment, when the application of the radio DSP parameter is cancelled while spending considerable time, the frequency of switching between the analog audio and the digital audio can be suppressed, and the sense of discomfort in audio can be reduced.

Hereinafter, a radio broadcast reception device of Embodiment 2 of the invention will be described with reference to the drawings. In the embodiment, components which are similar to those of Embodiment 1 are denoted by the same reference numerals, and their detailed description is omitted.

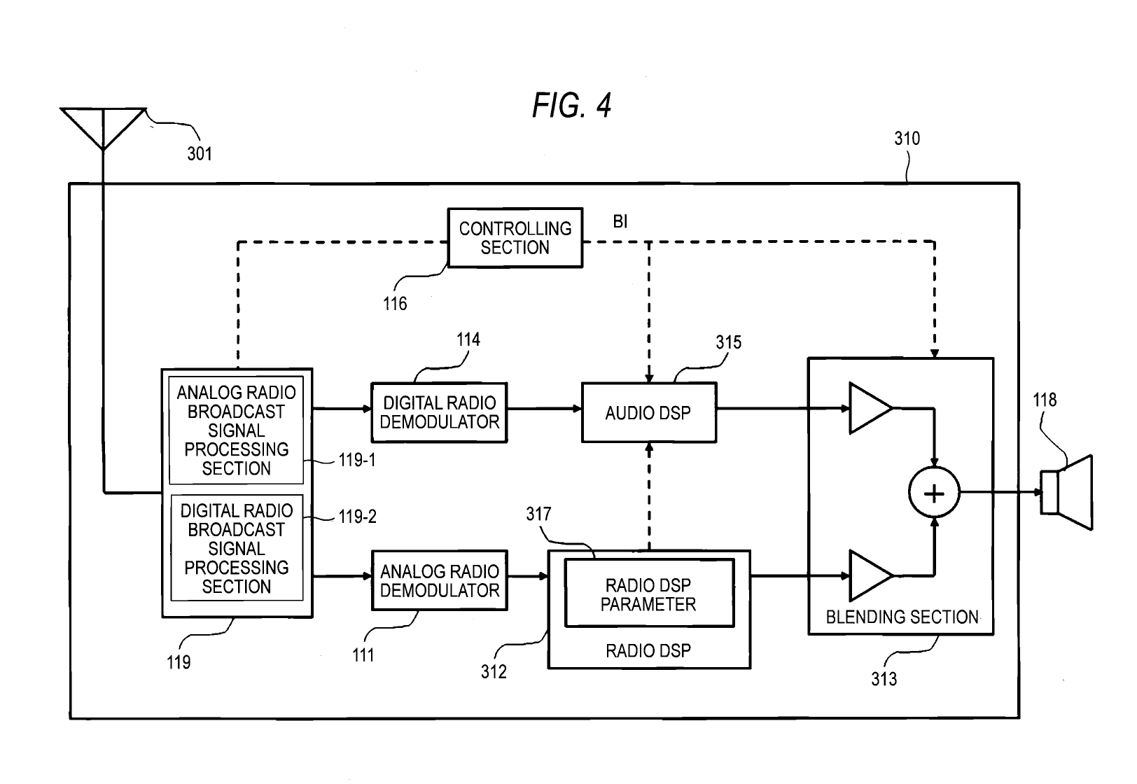

FIG. 4 is a block diagram of the radio broadcast reception device of Embodiment 2 of the invention. Referring to FIG. 4, the radio broadcast reception device 310 is a radio broadcast reception device for receiving a simultaneous broadcasting such as IBOC.

The radio broadcast reception device 310 includes: the analog radio demodulator 111 which demodulates an analog radio broadcast from the IF signal output from the analog radio broadcast signal processing section 119-1 of the broadcast signal processing section 119; and a radio DSP 312 which is connected to the analog radio demodulator 111, and which is used for performing a signal process pertaining to the sound quality, the volume, and the like on the signal demodulated in the analog radio demodulator 111.

Similarly, the radio broadcast reception device 310 includes: a digital radio demodulator 114 which demodulates a digital radio broadcast from the IF signal output from the digital radio broadcast signal processing section 119-2 of the broadcast signal processing section 119; and an audio DSP 315 which is connected to the digital radio demodulator 114, and which is used for performing a signal process pertaining to the volume, the sound quality, and the like on the signal demodulated in the digital radio demodulator 114.

The radio broadcast reception device 310 further has a blending section 313 which combines or switches (performs a blending process on) an analog radio audio signal that is an output signal of the radio DSP 312 and a digital radio audio signal that is an output signal of the audio DSP 315, and which outputs the result of the process to the subsequent stage.

Hereinafter, the process operation of the radio broadcast reception device 310 will be described.

First, the operation of the radio broadcast reception device 310 of the embodiment will be briefly described.

When the quality of the currently received wave is detected, the controlling section 116 switches the audio output of the radio broadcast reception device 310 in accordance with the detected quality.

When the audio output is to be switched, the controlling section 116 outputs the blend signal BI to the blending section 113 (for example, High is switched to Low, or Low is switched to High), whereby the switching operation is performed in the blending section 313, so that the digital radio audio output and the analog audio output are switched over.

The cases where the controlling section 116 performs switching between the digital radio audio and the analog audio are identical with those described in Embodiment 1.

Next, the process operation in the embodiment in the case where the audio output of the radio broadcast reception device 310 is switched from the analog radio audio output to the digital radio audio output, and that in the case where the audio output is switched from the digital radio audio output to the analog radio audio output will be described below.

The blend signal BI which is output from the controlling section 116 when the audio output of the radio broadcast reception device 310 is switched from the analog radio audio output to the digital radio audio output, or when the audio output is switched from the digital radio audio output to the analog radio audio output is supplied also to the audio DSP 315. The timing of application of a radio DSP parameter 317 is controlled by using the blend signal BI.

This point is similar to that in Embodiment 1. In the embodiment, however, at the same time when the invalidation of the parameter is advanced, also the volume level of the digital audio is gradually lowered (the detail will be described later). This is a process for taking volume matching because, when the invalidation of the parameter is advanced, the frequency characteristic of digital audio is widened, and the audio is heard as if the volume is increased.

According to the configuration, the analog audio can transit to the digital audio while the user (listener) feels a further reduced sense of discomfort.

By contrast, in the case where the digital radio audio output is to be switched to the analog audio output, in the switching, the radio DSP parameter is not applied immediately after the start of the switching, and the parameter is gradually validated as time progresses.

This causes the digital audio to gradually approach the analog audio characteristic, and is made identical with the analog audio characteristic immediately before the completion of the switching, whereby a sense of discomfort in audio during the switching can be reduced.

At the same time when the validation of the parameter is advanced, also the volume level of the digital audio is gradually raised (the detail will be described later).

This is a process for taking volume matching because, when the validation of the parameter is advanced, the frequency characteristic of digital audio is narrowed, and the audio is heard as if the volume is lowered.

According to the configuration, the digital audio can transit to the analog audio while the user (listener) feels a further reduced sense of discomfort.

Here, the radio DSP parameter 317 is used in order to apply a parameter applied to the analog radio audio, to the digital radio audio. When the radio DSP parameter 317 is supplied to the audio DSP 315, the signal process of the digital radio audio is performed in accordance with the parameter value.

Here, the parameter is a parameter which is used when the audio signal is subjected a signal processing in the audio DSP 315 so that the frequency characteristic and the like of the audio signal supplied to the audio DSP 315 have optimum values (values which are previously calculated and set in accordance with the field intensity in order to reduce the noise feeling of the received audio) in correspondence with a change (the reception situation) of the field intensity of the received broadcast wave, and includes a parameter for increasing or decreasing the audio separation value in correspondence with the increase or decrease of the field intensity, that for increasing or decreasing the amount of audio muting in correspondence with the increase or decrease of the field intensity, that for reducing the lower or higher frequency range in correspondence with the increase or decrease of the field intensity, etc.

In the embodiment, in addition to the above-described parameters, one parameter for adjusting the volume difference between digital audio and analog audio is added. The parameter is a parameter which is calculated from the value of the radio DSP parameter 317 by the radio DSP 312.

From the radio DSP parameter 317, it is known what kind of signal process is performed on the analog audio signal. In accordance with the process contents, the radio DSP 312 determines the value of a volume difference adjustment parameter.

In the case where the higher frequency range of the frequency characteristic of audio is reduced from the radio DSP parameter 317, when this is applied as it is to the audio DSP 315, for example, a volume difference is produced between the volume of audio which is obtained immediately after the application, and that in the case where the invalidation of the parameter is advanced.

The volume difference adjustment parameter is used for reducing the volume difference. From the parameter value of the radio DSP parameter 317, the volume difference to be reduced is calculated by the radio DSP, and the reduced volume is amplified by the audio DSP 315. Thereafter, at the same time when the invalidation of the parameter is advanced, the amplified volume level is gradually reduced.

By the above-described control, the volume difference between digital audio and analog audio can be reduced.

These parameters are stored in the form of a data table in a memory disposed in the radio DSP 312.

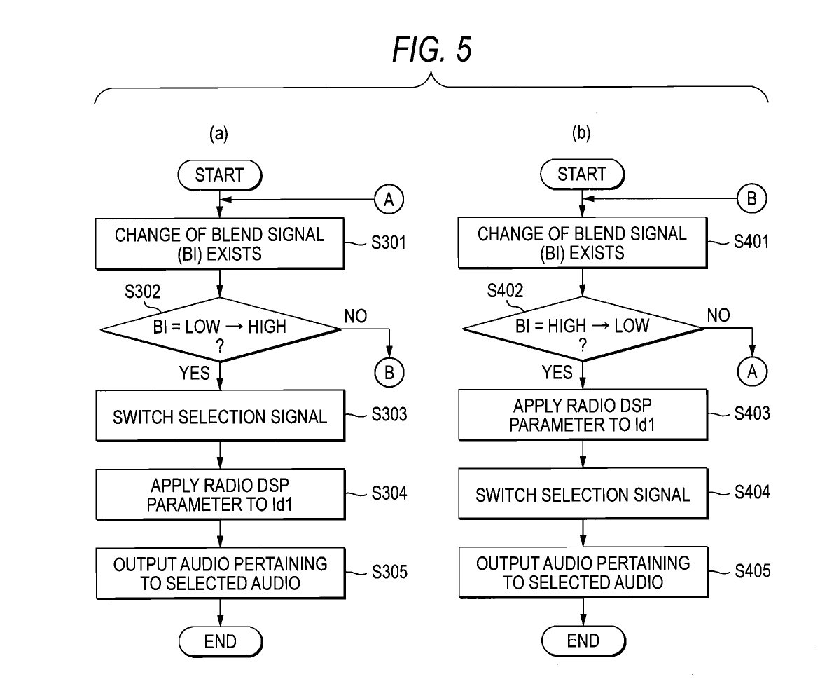

Hereinafter, the operation process flow of the radio broadcast reception device of Embodiment 2 will be described in detail with reference to flowcharts. FIG. 5 is a flowchart of the audio switching process in the radio broadcast reception device 310 of Embodiment 2 of the invention.

In the embodiment, when the audio output of the radio broadcast reception device 310 is to be switched from the analog radio audio output to the digital radio audio output, the output is switched by the blend signal BI as described above. In the following description, it is assumed that the blend signal BI is a signal having either of voltages indicative of two values of High and Low.

In the following description, after the blend signal BI is switched from Low to High, for example, the radio broadcast reception device 310 outputs the digital audio, and, after the blend signal BI is switched from High to Low, outputs the analog audio.

As shown in FIG. 5(a), the audio DSP 315 always monitors the existence of a High/Low change of the blend signal BI (step S301).

When it is detected in step S301 that the blend signal BI changes, the audio DSP 315 determines whether the blend signal BI changes from Low to High or not (step S302).

If the result of the determination in step S302 is No, i.e., if it is determined that the blend signal BI does not change from Low to High, the process of the audio DSP 315 is transferred to that of step S402 in the process flow shown in FIG. 5(b) which will be described later.

If the audio DSP 315 detects that a change from Low to High is conducted (Yes in step S302), the blending section 313 executes the blending process to switch the audio output of the radio broadcast reception device 310 from the analog audio to the digital audio (step S303).

At this time, the parameter (radio DSP parameter) which is supplied from the radio DSP is applied to the digital audio which is switched in step S303, by the audio DSP (step S304).

Thereafter, the digital audio to which the radio DSP parameter is applied in step S304 by the audio DSP is output as the audio output from the radio broadcast reception device 310 (step S305).

In the case where the radio DSP parameter is applied in step S304 to the digital audio by the audio DSP 315, the process is performed with a time constant τ3 as a predetermined time period for application (application time period).

As shown in FIG. 5(b), the audio DSP 315 always monitors the existence of a High/Low change of the blend signal BI (step S401).

When it is detected in step S401 that the blend signal BI changes, the audio DSP 315 determines whether the blend signal BI changes from High to Low or not (step S402).

If the result of the determination in step S402 is No, i.e., if it is determined that the blend signal BI does not change from High to Low, the process of the audio DSP 315 is transferred to that of step S302 in the process flow shown in FIG. 5(a) which has been described.

If the audio DSP 315 detects that a change from High to Low is conducted (Yes in step S402), the parameter (radio DSP parameter) which is supplied from the radio DSP 317 is applied to a digital audio signal Id, by the audio DSP 315 (step S403).

At this time, when the application of the radio DSP parameter to the digital audio signal Id1 in step S403 is completed, the audio output of the radio broadcast reception device 310 is switched from the digital audio to the analog audio (step S404).

In step S404, thereafter, the analog audio is output as the audio output from the radio broadcast reception device 310 (step S405).

In the case where the radio DSP parameter is applied in step 404 to the digital audio by the audio DSP 315, the process is performed with a time constant τ4 as a predetermined time period for application (application time period).

Here, a change of the output audio when the audio output is switched and the radio DSP parameter is applied to the digital audio will be described in detail.

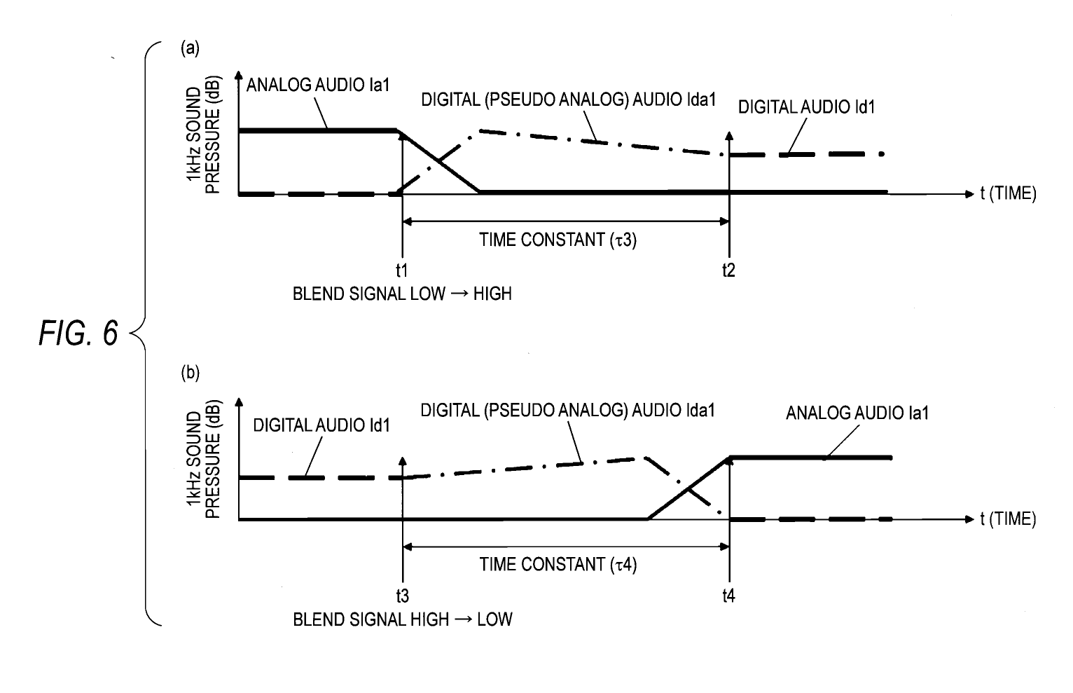

FIG. 6(a) is a view showing actual audio switching (the waveform which is monitored in the speaker 118 (see FIG. 4)). In the figure, the solid line indicates analog audio Ia1, the broken line indicates the digital audio Id1, and the dash-dot line indicates pseudo analog audio (digital audio to which the radio DSP parameter is applied) Ida1. As an audio signal, a 1 kHz tone is used.

In the period before time t1, as shown in FIG. 6(a), the analog audio Ia1 is reproduced. When the blend signal BI is switched from Low to High at time t1, the process of switching the output audio from the analog audio Ia1 to the digital audio Id1 is started in the audio DSP 315.

The period from time t1 to time t2 is a period which is set by the time constant τ3, and during which the process on the audio output is performed in the audio DSP 315 in the following manner.

In the period from time t1 to time tx, namely, the sound pressure of the analog audio Ia1 is gradually lowered, and that of the digital audio Id1 is gradually raised. At this time, the sound pressure of each audio is controlled so that the sum of the sound pressure of the analog audio and that of the digital audio is equal to the sound pressure of the analog audio which is obtained before time t1.

The digital audio at this time is the pseudo analog audio Ida1 (audio to which the radio DSP parameter is applied by the audio DSP 315).

In the pseudo analog audio Ida1, after time t1, the radio DSP parameter is instantly applied, and, after the application, the applied radio DSP parameter is gradually cancelled. Then, it reaches time t2.

For example, it is controlled so that, instantly at time t1, the radio DSP parameter is applied to the digital audio Id1, and, during the subsequent period until time t2, the application of the radio DSP parameter is gradually cancelled.

Similarly, it is controlled so that, from t1, also the volume difference adjustment parameter which is calculated from the radio DSP parameter is applied to the digital audio Id1, and, during the subsequent period from time tx to time t2, the application of the volume difference adjustment parameter is gradually cancelled.

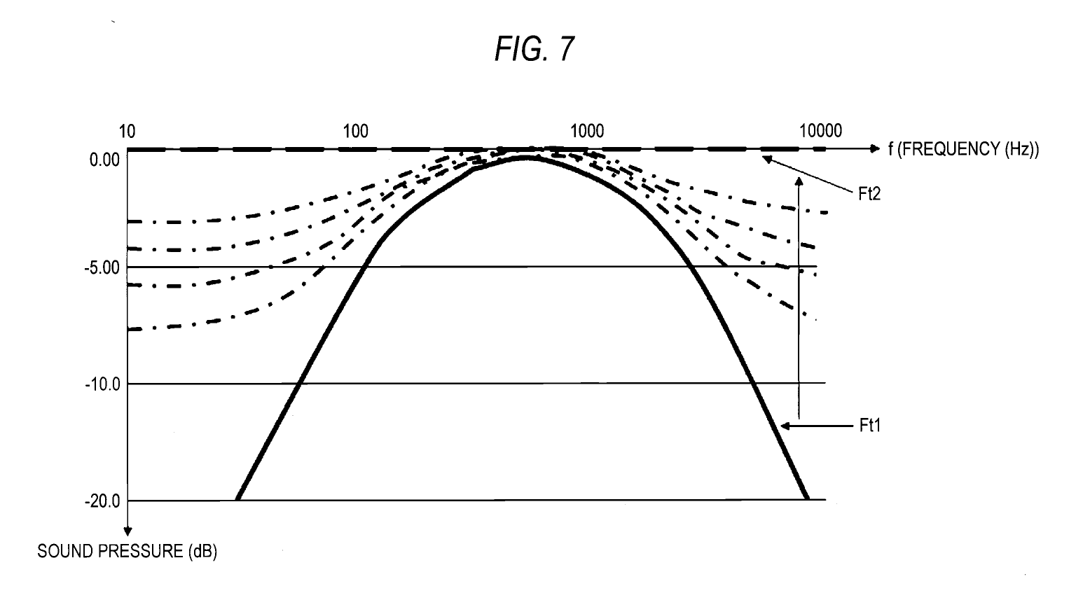

Hereinafter, the case where the volume difference adjustment parameter is applied will be described in detail with reference to FIG. 7. FIG. 7 is a view showing a change of the frequency characteristic in the output audio during the period from time t1 to time t2.

In FIG. 7, the frequency characteristic at time t1 is shown by the solid line, and indicated by Ft1. The frequency characteristic at time t2 is shown by the broken line, and indicated by Ft2.

Moreover, the temporal change of the frequency characteristic in the period from time tx to time t2 is shown by the dashed-dotted lines. In the drawing, namely, the time change of the frequency characteristic is shown by the plurality of dashed-dotted lines.

As shown in FIG. 7, since the radio DSP parameter is applied at time t1, the lower and higher frequency ranges of the audio signal in the frequency characteristic Ft1 are reduced.

During the period from time t1 to the transition from time tx to t2, the radio DSP parameter is gradually cancelled, and the sound pressure level to be reduced is lowered. Therefore, the volume of the sound output from the speaker 118 is increased.

When it is time t2, the radio DSP parameter is invalidated, and the frequency band to be reduced is eliminated. Therefore, the volume is maximum.

In the embodiment, therefore, the process is performed in which the volume difference adjustment parameter is applied at time t1 when the audio switching process is started, the volume is amplified by an amplification amount corresponding to the volume difference adjustment parameter, the volume difference adjustment parameter is gradually changed during the subsequent period when time tx transits to t2, thereby advancing the reduction of the volume amplification amount, and the volume is not amplified (the volume difference adjustment parameter is invalidated) at time t2.

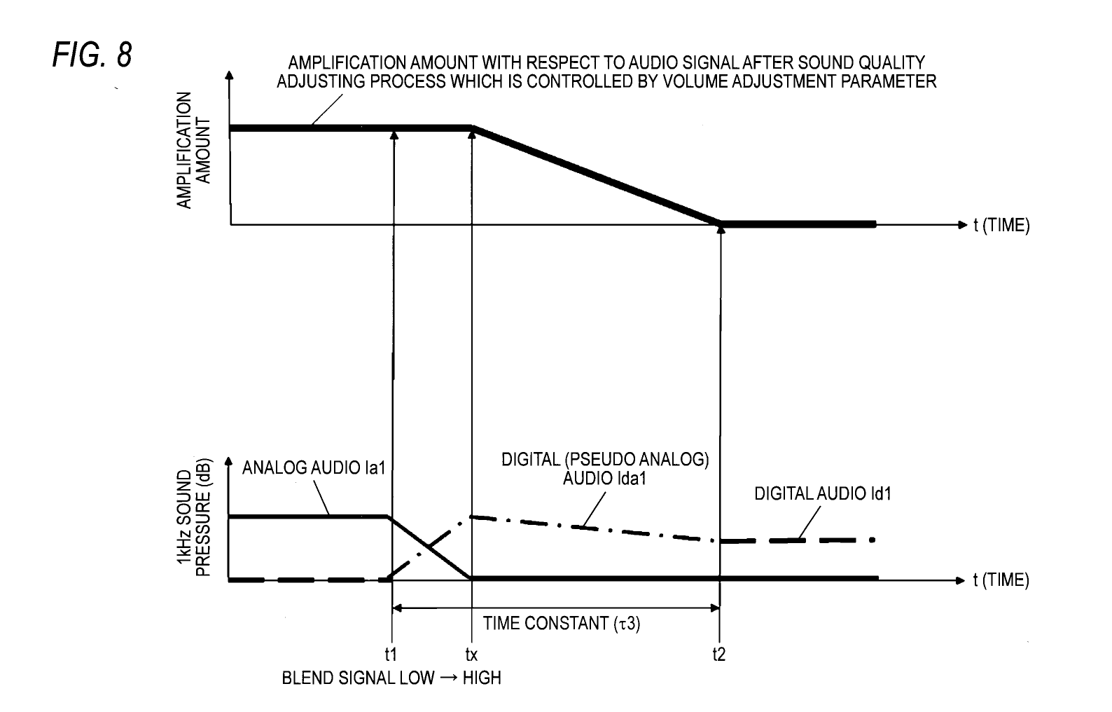

FIG. 8 shows a graph indicating a time change of the amplification amount of the signal which is specifically amplified by the volume difference adjustment parameter, in the upper side of the figure. In FIG. 8, in order to facilitate understanding of the description, the figure which is shown in FIG. 6(a), and which indicates the change of the sound pressure in the audio switching process is shown in the lower side of the figure.

After the volume difference adjustment parameter is applied at time t1, the amplification amount is gradually reduced during the period from tx to t2, and made 0 at time t2.

As a result of the above-described control, the sound pressure of each frequency after t1 is adjusted so as to, even after t1, be output at the same volume as that before t1.

However, the period (the period indicated by a time constant τ3) of the pseudo analog audio Ida1 is variable. After the radio DSP parameter is completely applied, it is possible that the application of the radio DSP parameter is instantly cancelled and the audio is returned to the digital audio Id1, and it is also possible that the audio is returned to the digital audio while spending considerable time.

The request for immediately listening to the digital audio Id1 can be complied by instantly cancelling the application of the radio DSP parameter. In a weak electric field area, however, the switching between the analog audio Ia1 and the digital audio Id1 frequently occurs, and therefore a noticeable sense of discomfort is produced during switching.

In the case where a sense of discomfort during switching is to be reduced, the application of the radio DSP parameter is cancelled while spending considerable time. According to the configuration, the frequency of switching between the analog audio Ia1 and the digital audio Id1 can be suppressed, and the sense of discomfort in audio can be reduced.

The case where the process of switching the output audio from the digital audio Id1 to the analog audio Ia1 is performed in the audio DSP 315 will be described in detail.

FIG. 6(b) is a view showing actual audio switching (the waveform which is monitored in the speaker 118 (see FIG. 4)). In the figure, the solid line indicates the analog audio Ia1, the broken line indicates the digital audio Id1, and the dash-dot line indicates the pseudo analog audio (digital audio to which the radio DSP parameter is applied) Ida1. As an audio signal, a 1 kHz tone is used.

As shown in FIG. 6(b), in the period before time t3, the digital audio is reproduced. When the blend signal BI is switched from High to Low at time t3, the process of switching the output audio from the digital audio Id1 to the analog audio Ia1 is started in the audio DSP 315.

The period from time t3 to time t4 is a period which is set by the time constant τ4, and during which the process on the audio output is performed in the audio DSP 315 in the following manner.

After time t3, namely, a process of gradually applying the radio DSP parameter to the digital audio so that the digital audio is made close to the analog audio Ia1.

The digital audio at this time is the pseudo analog audio Ida (audio to which the radio DSP parameter is applied by the audio DSP 315).

In the pseudo analog audio Ida1, after time t3, the radio DSP parameter is gradually applied, and, at the timing when it reaches time t4, the parameter is completely applied (at the timing when it reaches time t4, the characteristic is identical with the analog audio characteristic).

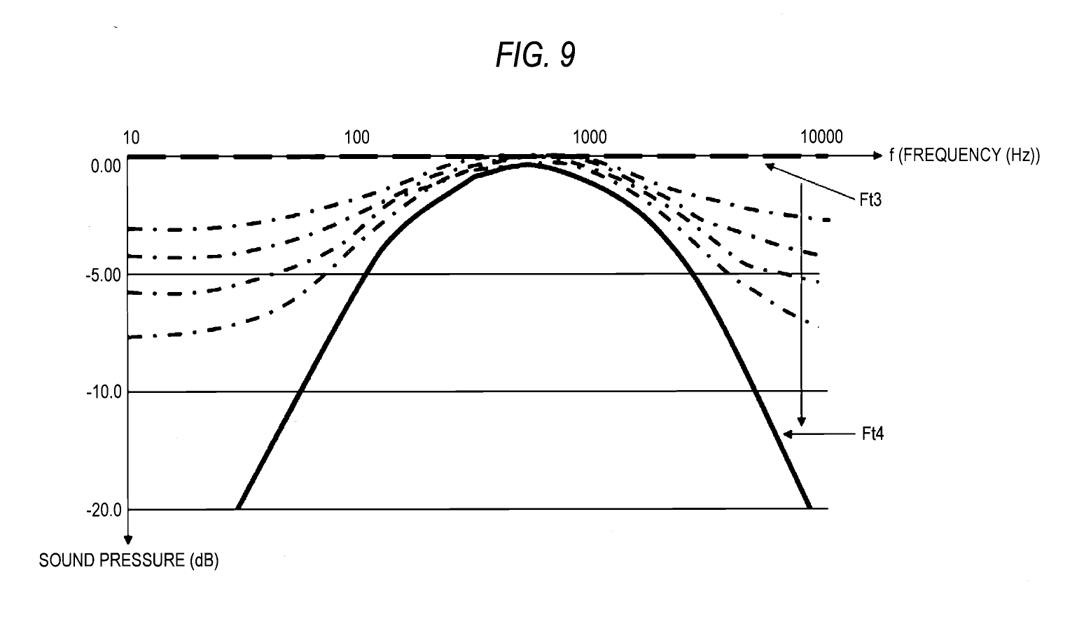

Similarly, a control is performed in which the volume difference adjustment parameter that is calculated from the radio DSP parameter begins at time t3 to be applied to the digital audio Id1, and thereafter the volume difference adjustment parameter is gradually applied during a period lasting until time t4. The process of applying the volume difference adjustment parameter will be described in detail with reference to FIG. 9.

FIG. 9 is a view showing a change of the frequency characteristic in the output audio during the period from time t3 to time t4.

In FIG. 9, the frequency characteristic at time t3 is shown by the broken line, and indicated by Ft3. The frequency characteristic at time t4 is shown by the solid line, and indicated by Ft4.

Moreover, the temporal change of the frequency characteristic in the period from time ty which is an arbitrary time in the period between time t3 to time t4, to time t4 is shown by the dashed-dotted lines. In the drawing, namely, the time change of the frequency characteristic is shown by the plurality of dashed-dotted lines.

As shown in FIG. 9, since the radio DSP parameter is not applied at time t3, the frequency band of the audio is not reduced.

During the transition from time t3 to time t4, the radio DSP parameter is gradually applied, and the sound pressure level to be reduced is advanced. Therefore, lowering of the volume is advanced.

When it is time t4, the radio DSP parameter is completely applied, and the lower and higher frequency ranges are reduced. Therefore, the volume is minimum.

By using the volume difference adjustment parameter, therefore, the audio DSP 315 performs the process in which nothing is performed at time t3, the volume amplification amount is gradually increased during the transition from time t3 to time t4, and the volume difference adjustment parameter is completely applied at time ty.

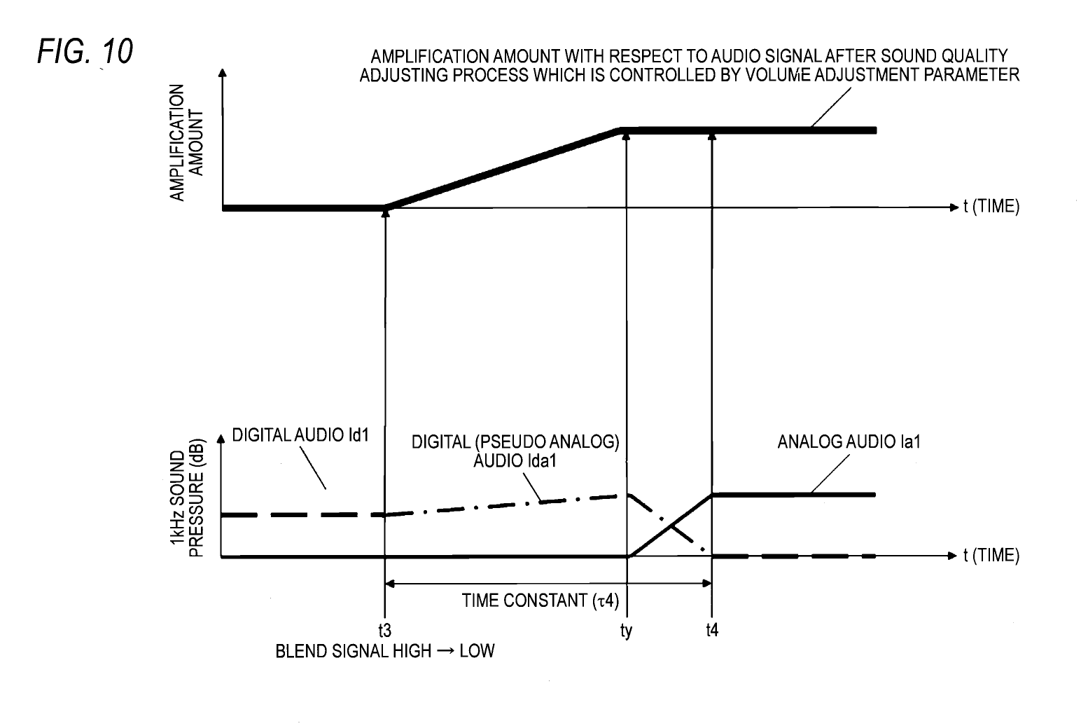

FIG. 10 shows a graph indicating a time change of the amplification amount of the signal which is specifically amplified by the volume difference adjustment parameter, in the upper side of the figure. In FIG. 10, in order to facilitate understanding of the description, the figure which is shown in FIG. 6(b), and which indicates the change of the sound pressure in the audio switching process is shown in the lower side of the figure.

The volume difference adjustment parameter begins at time t3 to be applied, and gradually increased in the period from time t3 to time ty. At time ty, the volume difference adjustment parameter is a value which is calculated from the radio DSP parameter.

At the timing when it reaches time t4, the process of switching between the digital audio (pseudo analog audio) and the analog audio is completed, and the analog audio Ia1 is output.

However, the period (the period indicated by the time constant τ4) of the pseudo analog audio Ida1 is variable. It is possible that the application of the radio DSP parameter is instantly performed and the audio is returned to the analog audio Ia1, and it is also possible that the audio is returned to the analog audio while spending considerable time.

The request for immediately listening to the analog audio Ia1 can be complied by instantly applying the radio DSP parameter. In a weak electric field area, however, the switching between the analog audio and the digital audio frequently occurs, and therefore a noticeable sense of discomfort is produced during switching.

In the case where a sense of discomfort during switching is to be reduced, the application of the radio DSP parameter is performed while spending considerable time. According to the configuration, the frequency of switching between the analog audio Ia1 and the digital audio Id1 can be suppressed, and the sense of discomfort in audio can be reduced.

As described above, the embodiment includes the audio DSP which can apply the radio DSP parameter. Therefore, the radio DSP parameter can be applied to digital audio, and a signal processing can be performed. Consequently, the digital audio can be conformed to the analog audio which is currently output.

The period when the radio DSP parameter is applied to the digital audio is set variable, whereby the parameter is made valid or invalid while spending considerable time. Therefore, a sense of discomfort during switching between analog audio and digital audio can be reduced.

In a weak electric field area, the switching between analog audio and digital audio frequently occurs, and therefore a noticeable sense of discomfort is produced during switching. Even in such an environment, when the application of the radio DSP parameter is cancelled while spending considerable time, the frequency of switching between the analog audio and the digital audio can be suppressed, and the sense of discomfort in audio can be reduced.

Furthermore, the volume of the digital radio audio is adjusted in accordance with the characteristics of the digital radio audio, whereby the user is enabled to listen to the output audio of the radio broadcast reception device, with a further reduced degree of a sense of discomfort as compared with the configuration where the characteristics (the frequency characteristic, the stereo/monaural characteristic, and the separation characteristic) of the digital radio audio are simply made close to those of the analog radio audio.

Although the invention has been described in detail and with reference to the specific embodiments, it is obvious to those skilled in the art that various changes and modifications can be made without departing from the spirit and scope of the invention.

### INDUSTRIAL APPLICABILITY

As described above, the radio broadcast reception device of the invention has an effect that, when the apparatus receives a simultaneous broadcasting such as IBOC (In-Band-On-Channel), a sense of discomfort in sound quality which is generated during switching between analog audio and digital audio can be reduced, and is particularly useful as a vehicle radio broadcast reception device in which audio switching frequently occurs.

### DESCRIPTION OF REFERENCE NUMERALS AND SIGNS

101 antenna
110, 310 radio broadcast reception device
111 analog radio demodulator
112, 312 radio DSP
113, 313 blending section
114 digital radio demodulator
115, 315 audio DSP
116 controlling section
117, 317 radio DSP parameter
118 speaker

1. A radio broadcast reception device in which, with respect to a digital radio broadcast and analog radio broadcast that are performing a simultaneous broadcasting, an audio output is switched between digital radio audio pertaining to the digital radio broadcast and analog audio pertaining to the analog radio broadcast, in accordance with a quality of a received radio wave of the digital radio broadcast, the radio broadcast reception device comprising:
a radio DSP that performs a signal process on analog radio audio by using a radio DSP parameter;
an audio DSP that performs a signal process on the digital radio audio by using an audio DSP parameter;
a controlling section that outputs a switching signal in accordance with the quality of the received radio wave of the digital radio broadcast; and
a blending section which switches between an output of the radio DSP and an output of the audio DSP, and
wherein, in accordance with the switching signal, while maintaining an output level constant, the blending section gradually switches between the output of the radio DSP and the output of the audio DSP during a predetermined time period.

2. The radio broadcast reception device according to claim 1, wherein, during the predetermined time period, the audio DSP performs, based on the radio DSP parameter, the signal process on the digital radio audio so as to bring a characteristic of the digital radio audio close to a characteristic of the analog radio audio which is currently received.

3. The radio broadcast reception device according to claim 2, wherein a time period of the signal process which is performed by the audio DSP is arbitrarily set within a range of the predetermined time period.

4. The radio broadcast reception device according to claim 3, wherein, in a case where the audio output is switched from the digital radio audio to the analog audio, the audio DSP gradually validates the radio DSP parameter as time progresses within the range of the predetermined time period after the audio DSP receives the switching signal.

5. The radio broadcast reception device according to claim 3, wherein, in a case where the audio output is switched from the analog radio audio to the digital audio, the radio DSP parameter is applied to the audio DSP instantly, within the range of the predetermined time period after the audio DSP receives the switching signal.

6. The radio broadcast reception device according to claim 5, wherein, after the instant application to a parameter of the audio DSP, the radio DSP parameter is gradually invalidated as time progresses.

7. A radio broadcast reception device in which, with respect to a digital radio broadcast and analog radio broadcast that are performing a simultaneous broadcasting, an audio output is switched between digital radio audio pertaining to the digital radio broadcast and analog audio pertaining to the analog radio broadcast, in accordance with a quality of a received radio wave of the digital radio broadcast, the radio broadcast reception device comprising:
a radio DSP that performs a signal process on analog radio audio by using a radio DSP parameter;
an audio DSP that performs a signal process on the digital radio audio by using an audio DSP parameter;
a controlling section that outputs a switching signal in accordance with the quality of the received radio wave of the digital radio broadcast; and
a blending section which switches between an output of the radio DSP and an output of the audio DSP, and
wherein, in accordance with the switching signal, the blending section gradually switches between the output of the radio DSP and the output of the audio DSP during a predetermined time period to gradually change an output amount of the audio DSP during the predetermined time period.

8. The radio broadcast reception device according to claim 7, wherein, during the predetermined time period, the audio DSP performs, based on the radio DSP parameter, the signal process on the digital radio audio so as to bring a characteristic of the digital radio audio close to a characteristic of the analog radio audio which is currently received.

9. The radio broadcast reception device according to claim 8, wherein a time period of the signal process which is performed by the audio DSP is arbitrarily set within a range of the predetermined time period.

10. The radio broadcast reception device according to claim 9, wherein, in a case where the audio output is switched from the digital radio audio to the analog audio, the audio DSP gradually validates the radio DSP parameter as time progresses within the range of the predetermined time period after the audio DSP receives the switching signal, and an output amount of the digital audio is gradually lowered.

11. The radio broadcast reception device according to claim 9, wherein, in a case where the audio output is switched from the analog radio audio to the digital audio, the radio DSP parameter is applied to the audio DSP instantly, within the range of the predetermined time period after the audio DSP receives the switching signal, and an output amount of the digital audio is gradually raised.
